(19) United States
(12) Patent Application Publication
(10) Pub. No.: US 2010/0198823 A1
(43) Pub. Date: Aug. 5, 2010

(54) SYSTEMS AND METHODS TO AUTOMATICALLY GENERATE ENHANCED INFORMATION ASSOCIATED WITH A SELECTED WEB TABLE

(76) Inventors: Kathleen J. Tsoukalas, Burnaby (CA); Jian Pei, Coquitlam (CA); Davor Cubranic, Vancouver (CA)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/366,068

(22) Filed: Feb. 5, 2009

(51) Int. Cl. G06F 17/30; G06F 15/16

(52) U.S. Cl. 707/736; 709/219; 707/E17.108

(57) ABSTRACT

According to some embodiments, a system, method, means, and/or computer program code are provided to facilitate use of a data sharing web server remote from a user device. According to some embodiments, information from a remote web resource server may be received at the user device (and the received information may include tabular data comprising cells arranged in a plurality of rows and a plurality of columns). A user selection of a portion of the received information may also be received at the user device, and the selected portion may include the tabular data. Enhanced information associated with the selected portion may be automatically generated and transmitted to the remote data sharing web server.

### FIELD

Some embodiments of the present invention relate to data sharing web service. In particular, some embodiments relate to systems and methods to automatically generate enhanced information associated with a selected web table to be uploaded to a data sharing and/or collaboration web site.

### BACKGROUND

A user at a user device may receive and view content from a remote resource server. For example, a user at a Personal Computer (PC) executing a web browser program may receive and view a web page from a remote web server via the Internet. In some cases, the user may wish to upload information to a remote server. For example, a user at a PC might want to upload information to a data sharing or collaboration service so that the information can be viewed and/or modified by other users. To upload the information, the user might simply enter the information (e.g., using his or her keyboard). Such an approach, however, can be time-consuming and error prone, especially when a relative large amount of data is to be uploaded.

A user might also attempt to “cut and paste” information he or she is viewing from one web server to be uploaded to another web server. Unfortunately, common formatting techniques for presenting data when selected may result in incorrect or missing content being copied. For example, particular cells that are arranged in a table may fail to include the appropriate data.

Moreover, when uploading information to a web sharing service it may be helpful to include metadata that describes the content. For example, if a table of values associated with the yearly average income of employees in various geographic regions is uploaded to a data sharing service, it might be helpful to indicate that the table is associated with “salaries.” Such metadata might, for example, help other users locate the information in an efficient manner. In some cases, however, a user may fail to provide such metadata or provide descriptions that are incomplete and/or inaccurate.

It would therefore be desirable to provide improved methods and systems that facilitate the sharing of information by a user.

### BRIEF DESCRIPTION OF THE DRAWINGS

FIG. 1 is a diagram of a system according to some embodiments of the present invention.

FIG. 2 is a flow diagram of a method for operating an analyzer module and spreadsheet application according to some embodiments of the present invention.

FIG. 3 illustrates a user display including tabular information according to some embodiments.

FIG. 4 illustrates a user display including user-selected content according to some embodiments.

FIG. 5 is a diagram of a system according to some embodiments of the present invention.

FIG. 6 is a flow diagram of a method for determining a list of suggested tags to describe tabular data in accordance with some embodiments.

FIG. 7 illustrates a wizard display including a preview of suggested tabular data according to some embodiments.

FIG. 8 illustrates a wizard display including suggested data descriptions of the tabular data according to some embodiments.

FIG. 9 is a block diagram of a system architecture according to some embodiments of the present invention.

FIG. 10 is a block diagram of an apparatus in accordance with some embodiments of the present invention.

### DETAILED DESCRIPTION

To alleviate problems inherent in the prior art, some embodiments of the present invention introduce systems, methods, computer program code and/or means to automatically generate enhanced information associated with a selected web table to be uploaded to a data sharing and/or collaboration web site.

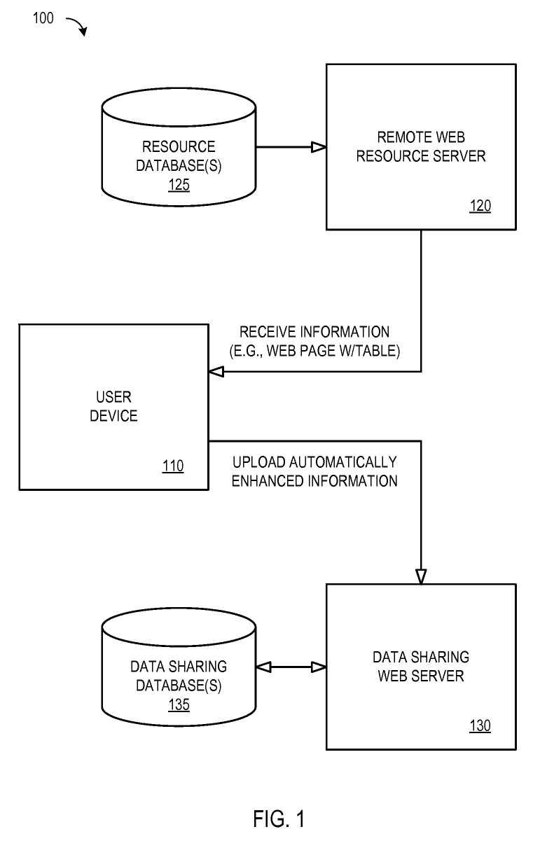

FIG. 1 is a diagram of a system 100 according to some embodiments of the present invention. The system 100 includes a user device 110, such as a PC, workstation, set-top device, or mobile computer. The user device 110 may, for example, execute a browser program that receives information from a remote web resource server 120. The remote web resource server 120 might, for example, retrieve information such as text, graphics, videos, audio content, and/or tabular content from one or more resource databases 125 and transmit the information to the user device 110 via the Internet. As used herein, the term “web” site or server may be associated with any resource provided via a communication network such as the Internet.

A user might then view the received the information and determine that some or all of the information should be shared with other users by transmitting the data to a web server 130 associated with a data sharing and/or collaboration service. Examples of such services include web 2.0 sites, social networking sites, ManyEyes from IBM®, GapMinder, and Whohar or OnDemand from SAP® BusinessObjects™. These applications can be hosted on a web server and access across the internet or another network like an intranet. These types of services may encourage users to work on datasets collaboratively (and build visualizations based on those datasets) and encourage people to form communities that help them share and discover new information. The data sharing web server 130 might, for example, store information received from many users in one or more data sharing databases 135.

To upload information to the data sharing and/or collaboration web server 130, the user might simply enter the information via the user device 110 (e.g., by typing the information using his or her keyboard). Such an approach, however, can be time-consuming and error prone, especially when a relative large amount of data is to be uploaded.

The user might also attempt to “cut and paste” information he or she is viewing from the remote web resource server 120 to be uploaded to the data sharing web server 130. Unfortunately, formatting issues associated with the data may result in incorrect or missing content being copied. For example, particular cells that are arranged in a table may fail to include the appropriate data.

Moreover, when uploading information to the data sharing web server 130 it might be helpful to include metadata that describes the content. For example, if a table illustrating people's preferences with respect to various brand names is uploaded to the data sharing web server, it might be helpful to indicate that the table is associated with “logos” and “popularity.” Such metadata might, for example, help other users locate information from the data sharing databases 135 in an efficient manner. In some cases, however, a user may fail to provide such metadata or provide descriptions that are incomplete and/or inaccurate.

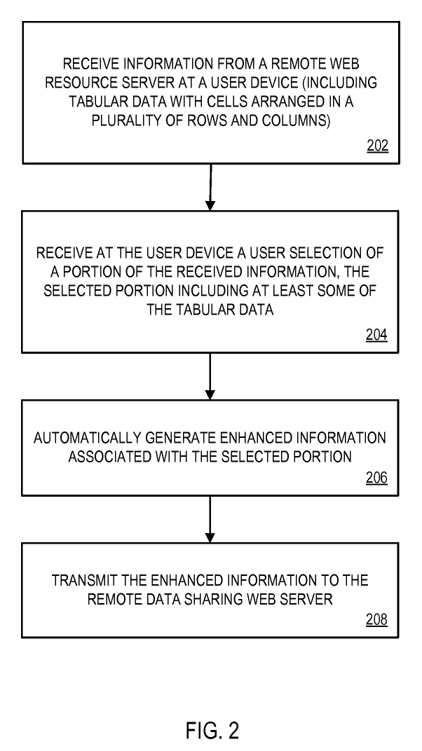

To improve the sharing of content by users, the system 100 may automatically generate enhanced information for data being uploaded to the data sharing web server 130. For example, FIG. 2 is a flow diagram depicting process steps that may be used to facilitate use of the system 100 of FIG. 1. The flow charts described herein do not necessarily imply a fixed order to the actions, and embodiments may be performed in any order that is practicable. Note that any of the methods described herein may be performed by hardware, software (including low level language code), or any combination of these approaches. For example, a storage medium may store thereon instructions that when executed by a machine result in performance according to any of the embodiments described herein.

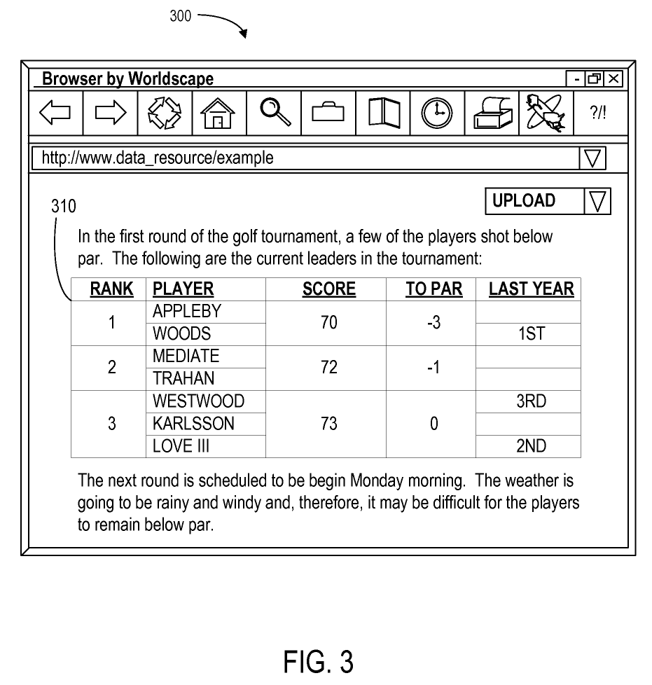

At 202, the user device 110 receives information from the remote web resource server 120. For example, the remote web resource server 120 might transmit a web page to the user device 110. According to some embodiments, the received information includes “tabular” data. As used herein, the term “tabular” data may refer to any type of content that includes cells arranged in a plurality of rows and columns. Examples of tabular data include content formatted as word processing tables and/or spreadsheet arrangements. By way of example, FIG. 3 illustrates a user display 300 including tabular information 310 according to some embodiments. In this case, the tabular information 310 includes cells arranged in rows (e.g., associated with various golf players arranging according to their rank) and columns (e.g., providing information about the player's score).

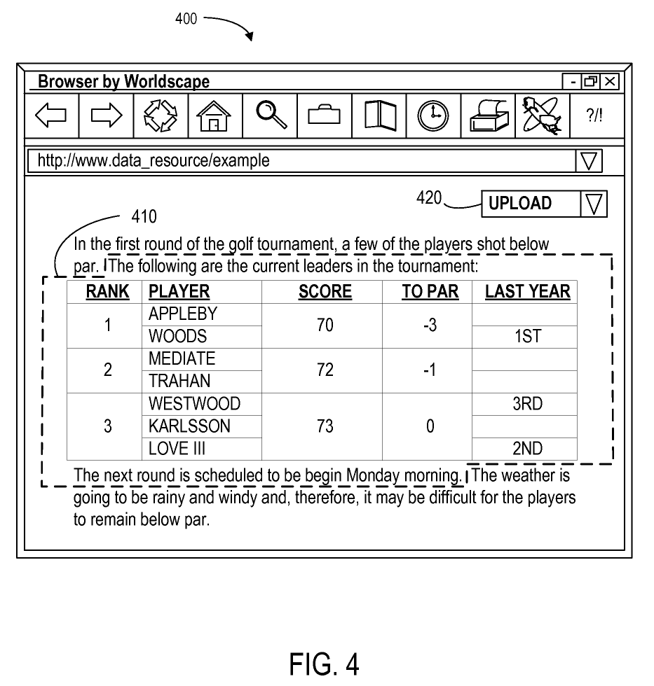

At 204, the user device 110 receives a user selection of a portion of the received information. For example the user might use a keyboard or mouse to highlight or otherwise select some or all of the content on a web page. According to some embodiments, the selected portion includes the tabular data. By way of example, FIG. 4 illustrates a user display 400 including user-selected content 410 according to some embodiments. In this case, the user has selected the portion of the web page: (i) that begins with the text “The following . . . ,” (ii) includes the entire table of player information, and (iii) ends with the text “Monday morning.” A user selection can be the data or an identifier to the data.

The user might then indicate that he or she wishes to provide the selected information to the remote data sharing web server 130. For example, he or she might activate an “upload” icon 420 associated with a plug-in or bookmarklet to initiate the data sharing process. As used herein, the term “bookmarklet” may refer to an applet or other small computer application associated with a web browser that performs a function. By way of example, a bookmarklet might be implemented as a JavaScript program or other script to be executed by a web browser.

At 206, enhanced information is automatically generated in connection with the selected portion 410. For example, the user device 110 might automatically generate formatting information and/or metadata information to be associated with the selected portion. At 208, the user device 110 may transmit the enhanced information (along with the content selected by the user) to the remote data sharing web server 130.

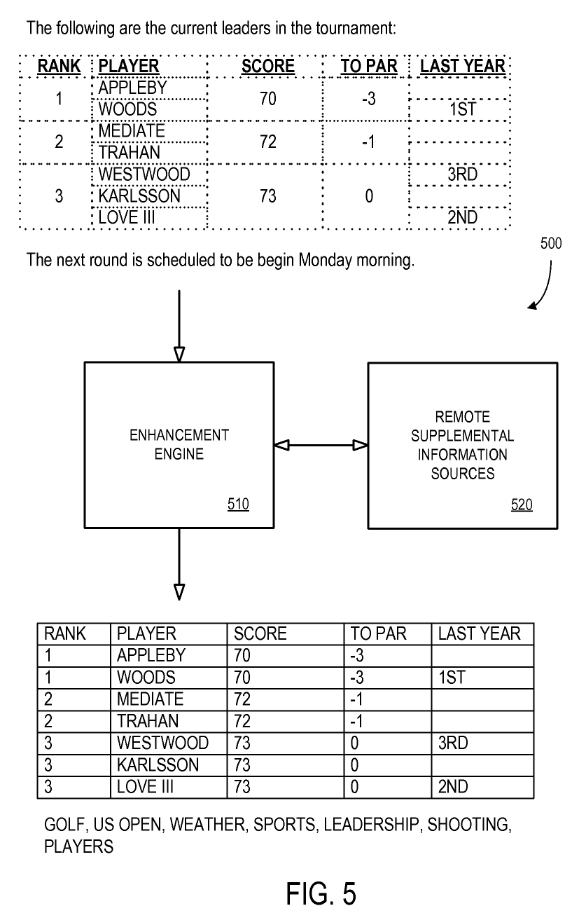

Consider FIG. 5 which is a diagram of a system 500 that might be associated with the user device 110 according to some embodiments of the present invention. In this case, an enhancement engine 510 might analyze the selected content and generate information that is re-formatted or otherwise enhanced for a data sharing service. In some cases, the enhancement engine 510 might access one or more remote supplemental information sources 520 (e.g., third party search engines) to determine how the selected information should be enhanced.

In some case, the selected content information might be enhanced by maintaining or re-formatting tabular information. For example, data might be replicated from a first cell of the tabular data into a second cell to account for a span in the formatting of tabular information. In the display of FIG. 4, the score “70” might be replicated such that it is included in rows for both players “Appleby” and “Woods.” As another example, the enhanced information might be formatted so as to ensure that a first cell is blank to account for a gap in the formatting of tabular information. For example, the “Last Year” value for player “Trahan” might be left blank (e.g., because that player did not participate in the tournament last year).

In other cases, the selected content information might be enhanced by determining metadata to associated with the tabular data. For example, the metadata might include at least one description of the tabular data (e.g., a title or short description of the information included in a selected table). As another example, the metadata might include at least one tag or keyword that should be associated with the tabular data. The metadata might be generated, for example, in accordance with (i) preset general tags, (ii) keywords, (iii) a pseudo-relevance process, (iv) a clustering process, (v) search results associated with the tabular data, (vi) a relevance score, and/or (vii) a confidence score.

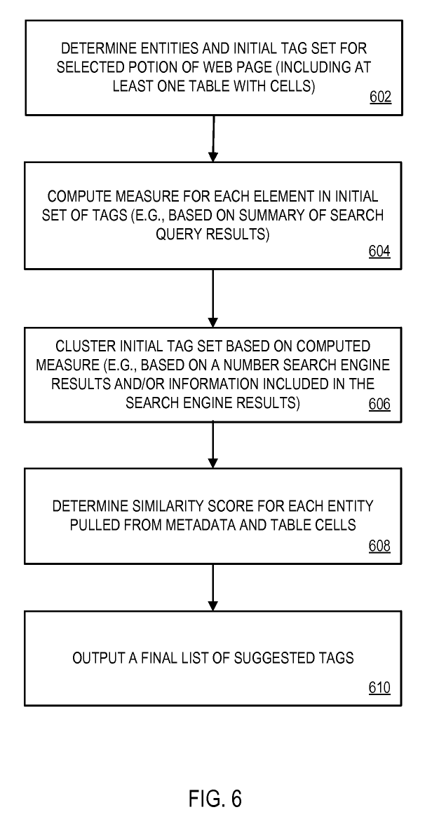

Note that the enhancement information might represent a set of keywords or tags that describe the selected tabular data. In an embodiment, the tags are appropriate and range from general to specific. Note the remote supplemental information source 520 may include one or more search engines (e.g., associated with the Google® search engine). For example, FIG. 6 illustrates one method for determining a list of suggested tags to describe tabular data in accordance with some embodiments. At 602, a set of entities may be determined in connection with selected tabular data along with an initial tag set. For example, table headings or text from paragraphs surrounding a table may be used as entities and an initial tag set might be taken from a pre-determined list of popular tags.

At 604, a measure is computed for each element of the initial set of tags. For example a search engine is queried and the results or a summary of the results serve as a measure. At 606, the initial tag set is clustered based on the measure, e.g., search results. As will be described, the tag set might be clustered in accordance with, for example, an adapted quality threshold clustering method or an agglomerative hierarchical clustering method. The clustering might be based at least in part on, for example, a number of search results received from the search engine and/or information included in the search engine results.

At 608, a similarity score may be determined for each entity pulled from the metadata and/or table cells. The similarity score might be based on, for example, a number of search results received from the search engine and/or information included in the search engine results.

At 610, a final list of suggested tags may be provided as an output. For example, the final list of suggested tags may be displayed to a user (who may then decide to accept or modify the suggestions).

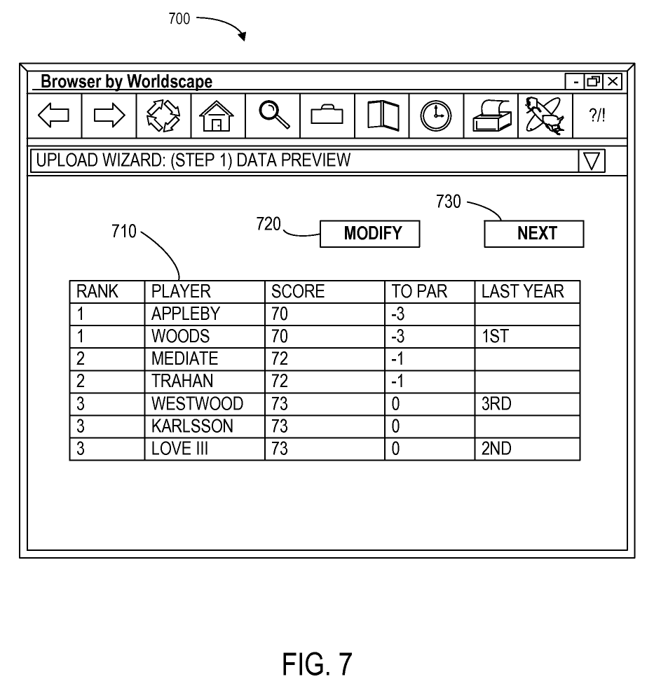

According to some embodiments, the enhancement engine 510 automatically generates “suggested” enhanced information associated with the selected portion. An indication may then be received from the user (e.g., indicating that he or she agrees with or modifies the suggested enhancement), enhanced information transmitted to the data sharing web server 130 is based at least in part on the received indication. For example, FIG. 7 illustrates a wizard display 700 including a preview of suggested tabular data 710 according to some embodiments. That is, the suggest tabular data 710 has been automatically formatted by the enhancement engine 510 (e.g., by replicating cell content and/or inserting blank cells as appropriate). The user might then select a modify icon 720 to change the suggest tabular format or indicate that the suggested tabular format is acceptable by selecting a next icon 730.

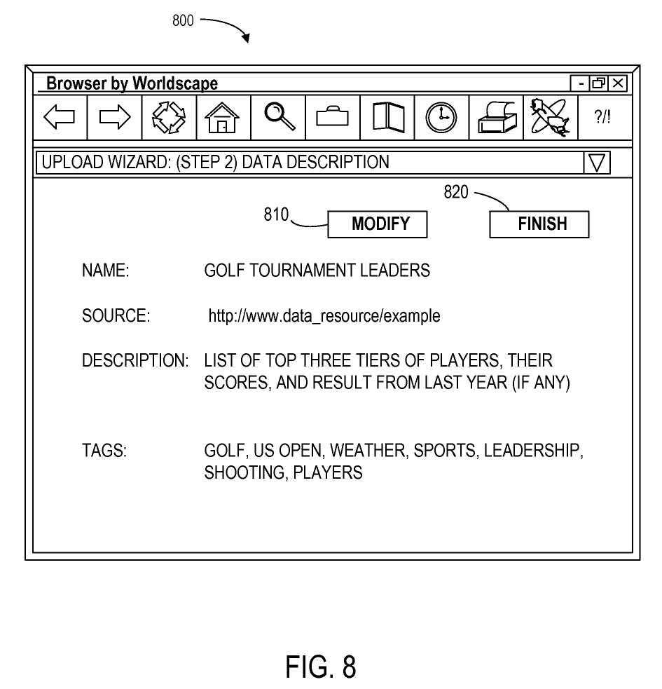

Similarly, FIG. 8 illustrates a wizard display 800 including suggested data descriptions of the tabular data according to some embodiments. In particular, the suggest metadata descriptions include a name for the data being uploaded, the source (e.g., the URL associated with the original table), a brief description of the table, and a set of tags or keywords that will be associated with the table. The user might then select a modify icon 810 to change the suggest metadata or indicate that the suggested tabular format is acceptable by selecting a finish icon 820. The user might, for example, delete some of the suggested tags and/or add some new tags before selecting the finish icon 820 to initiate the upload of information to the data sharing web server 130.

Note that the work flow and automatic generation of metadata might be implemented in a number of different ways. By way of example only, a user might first select a table in a webpage by clicking and dragging with the mouse to highlight it. Next, the user may click a bookmarklet button in the browser window. The bookmarklet's function may include parsing the HyperText Markup Language (HTML) table and extracting specified areas from the webpage, such as the first paragraph, immediately surrounding paragraphs, page title, and/or a table title. The data might then be sent to a Java program which processes the text to find keywords or entities within it. These entities may be compared to a set of tags, which might consist of preset general tags as well as tags resulting from a pseudo-relevance feature. This set of tags might, for example, be initially clustered according to generality (according to a number of search results each tag provides). A comparison of each tag and entity may then be performed, with each tag being assigned a score resulting from a search engine measure (e.g., a Google distance measure). The top tag in each cluster might then be chosen and together these may form a final set of tags to be recommended as part of the metadata.

Tags included in the initial set of tags may be taken from a number of different sources. For example, the “k” most popular categories associated with an online information resource (e.g., Wikipedia categories) might be used along with a set of tags retrieved from a pseudo relevance feedback feature. For example, the tag set might be initially populated with the k most popular categories in Wikipedia (as well as the “m” most popular tags in another resource). According to some embodiments, the categories from Wikipedia may be replaced by a set of domain-specific categories. Such an approach provide tags with a good level of generality, but may not be specifically related to the table the user wishes to tag. Thus, the system may expand the tag set with specific, relevant tags according to the particular resource being tagged.

This might be accomplished, for example, using a pseudo relevance process to expand the initial tag set. For example, if the system performs a web query based on the title (or similarly representative excerpt of text from the dataset being tagged), the most frequent keywords in the snippets of top ten (or other pre-determined number) results may be highly related to the dataset. Using either the title or other metadata found for the dataset, the system may therefore first perform a web search. Next, entities may be extracted from these resulting snippets. Each entity may have a relevance and confidence score based on how confident the system is that this entity was correctly selected and how related it is to the original document. The system may combine these scores to form a final score for each entity. The system might then take the top ten percent of tags found with the highest scores and add these to the initial tag set. As a result, the set may be expanded to include tags with greater specificity as compared the original Wikipedia categories.

Once the initial tag set and entity set are determined, the system might perform steps that make up an automatic tagging algorithm or technique. As used herein, the term technique may refer to, for example, a series or steps or processes that receive an input and provide an output. The automatic tagging technique might, for example: (i) receive as an input the initial tag set and set of entities retrieved from table and metadata; and (ii) provide as an output a final list of tags, possibly decreased in size. By way of example, the following method might be used to perform such a process:

```
receive an initialTagSet
get Google results for each tag in the initialTagSet
use clustering to group initial tag set according to each tag's results
for each entity pulled from the metadata and table cells do
    use a main tagger technique to get similarity score for each tag and
    store the top k in a listOfTags
end for
return the listOfTags
```

This technique refers to several subsidiary techniques, which will now be described in further detail.

For example, a “main tagger” technique might: (i) receive as an input an initial tag cluster list C={c₀, c₁, . . . , c, . . . , cₙ₋₁}, an initial entity set E={e₀, e₁, . . . , e, . . . , eₙ₋₁}, and set of entities retrieved from table and metadata; and (ii) provide as an output a final list of tags as follows:

```
for each entity e in the initial entity set E do
    gₑ := the number of Google results from querying e
    for each entity e do
        tagList := populateTagList(e, c, g)
    end for
end for
for each tag t ε {T in C} do
    Find the average score for t
end for
for each cluster c ε C do
    add the top 1 (or 2) tag in c to listOfTags
end for
return listOfTags
```

Similarly, a populate tag list technique might receive as an input the cluster c, entity e, and Google result number from querying entity g as follows:

```
for each tag t in the cluster c do
    gₑ := the number of google results from querying e
    gₜ := the number of google results from querying t
    g_{t,e} := the number of google results from querying t + e
    score := similarityScorer(g_{t,e},gₜ,gₑ)
    add {t, score} to listOfTags
end for
return listOfTags
```

According to some embodiments, a “similarity” distance score is used to enhance tabular data. For example, the system might calculate the similarity score with the following equation (e.g., a “Google similarity distance” measure):

$$similarityScorer ( {g}_{t} , {g}_{e} , {g}_{t , e} ) = \frac{max ( log ( {g}_{t} ) , log ( {g}_{e} ) ) - log ( {g}_{t , e} )}{log N - min ( log ( {g}_{t} ) , log ( {g}_{e} ) )}$$

Here, N is an estimate of the number of pages indexed by the web search service (e.g., N might be approximately 10×10¹¹).

Note that different clustering methods might be used in connection with the automatic generation of enhanced information for tabular data to be shared. In an embodiment, the distance measure in clustering in the similarity distance. One example of such a clustering method is adapted quality threshold clustering. In this case, tags may be clustered by a variant of the method quality threshold clustering. First, given an initial set of tags, the system may obtain the number of Google results for each. That is, the tag is supplied to a search engine and the number of results may be recorded. Next, the system uses quality threshold clustering to group these tags according to this number.

In particular, a user may choose a maximum diameter (d) for clusters and a set of tags to be clustered (G). The procedure may be called for an instance of the minimum diameter and the set of tags. For each tag (indexed as i), a candidate cluster (Aᵢ) is formed by starting with the instant tag (i). The candidate cluster may be expanded by adding in the additional tag (indexed as j) that keeps the diameter of the candidate cluster to a minimum. All tags in G that are not in the candidate cluster Aᵢ may be considered, hence j ε G−Aᵢ. The process may continue until no tag can be added without exceeding the diameter limit d.

These acts create a set of clusters, and the clusters are not mutually exclusive. Normally, the cluster of the largest size (cardinality) is outputted as the selected cluster from this round. The procedure may then be called for another round for the set of tags minus the selected cluster G−C. Here diameter may be a measure of a cluster defined as difference: g(t,M)−g(t,m) or g_{t,M}−g_{t,m}. That is for the cluster the maximum difference in Google results for the tags in the cluster. By definition a cluster of one tag may have a diameter of zero.

The pseudo code for the general technique of quality threshold clustering may be represented as:

```
Procedure QT_Clust(G,d)
if (|G| ≦ 1) then output G, else do /* Base case */
    for each i ε G
        set flag = TRUE; set Aᵢ = {i} /*Aᵢ is the cluster started by i */
        while ((flag = TRUE) and (Aᵢ ≠ G))
            find j ε (G − Aᵢ) such that diameter Aᵢ ∪ {j} is minimum
            if diameter Aᵢ ∪ {j} > d
                then set flag = FALSE
                else set Aᵢ = Aᵢ ∪ {j} /* add j to cluster Aᵢ */
    end for
    identify set C ε {A₁, A₂, ..., A_{|G|} } with max cardinality
    output C
    call QT_Clust(G−C, d)
```

In some cases, the list of clusters provided may include clusters too small to be useful. An adaptation of quality threshold clustering may be useful in these cases. These clusters might be identified through quality threshold clustering and then all clusters with a size below the average cluster size might merged with their nearest neighbor. Note that it may be possible to substitute the average cluster size for other threshold values, such as a percentage of the average cluster size or the median of the cluster size.

Another clustering method that might be used in connection with the automatic generation of enhanced information for tabular data is agglomerative hierarchical clustering. Although the results may be similar, the agglomerative hierarchical method may have the advantage of fixed cluster sizes. A disadvantage might be that groups can have larger diameters than they might be if the quality threshold cluster and merge strategy were used instead.

Agglomerative hierarchical clustering may iteratively group similar categories together. The technique may start by considering each individual category as its own cluster, and then merge the most similar clusters at each step until there is only a single cluster. The system measure one cluster's similarity to another's by finding the average, or cluster center, of the number of search results for each category within the cluster using the Jaccard distance:

$$JaccardDist = \frac{{clusterCenter}_{1} \times {clusterCenter}_{2}}{\begin{matrix}( {clusterCenter}_{1}^{2} + {clusterCenter}_{2}^{2} ) - \\ ( {clusterCenter}_{1} \times {clusterCenter}_{2} )\end{matrix}}$$

Such an approach may be referred to as average-linking agglomerative hierarchical clustering.

If the agglomerative hierarchical clustering technique is allowed to run completely, the system may end up with a hierarchy of clusters in the form of a tree (or dendogram), which can be traversed such that at different levels a different number of clusters may be found. According to some embodiments, the system may simply stop once it has the desired number of clusters rather than running the technique to completion. The technique may be stopped once the number of clusters becomes greater than ten. In this way, taking the top tag from each cluster yields a final recommendation list of ten tags.

One example of an agglomerative hierarchical clustering technique will not be provided. This clustering approach might, for example: (i) receive as an input a list of categories (catList); and (ii) provide as an output a list of clusters (clusterList). By way of example only, the following steps might be used to perform such a process:

```
for each category (Cᵢ) in catList do
    create a new cluster (Iᵢ) containing cᵢ
    add Iᵢ to clusterList
end for
while the size of the clusterList > 10 do
    for each cluster Iᵢ in clusterList do
        find Jaccard_Dist of Iᵢ to each other cluster Iⱼ in clusterList
            if Iᵢ != Iⱼ do
                find Jaccard_Dist (Iᵢ, Iⱼ)
                if this distance is smallest do
                    store the indexes i and j for elements
    end for
    merge cluster Iᵢ and Iⱼ, store as newCluster
    remove Iᵢ and Iⱼ from clusterList
    add newCluster to clusterList
end while
```

This technique refers to several subsidiary techniques, which will now be described in further detail.

Once the system has the tags clustered, for each keyword in the original metadata a Google distance to each tag in each cluster may be obtained. Since each tag may be compared multiple times, the system may take the average of all scores for each tag to get the final score. The reason for taking the average score and not the maximum or minimum score is to prevent one or two very good matches (or very poor matches) from skewing the final score. Depending on the implementation, one could use the mean or median as the average score.

Finally, the system may select the top one or two tags from each cluster (the number of tags selected can be tuned depending on which clustering method is used and how many tags should be recommended), and these tags will form the final tag set. This allows for the most relevant tags from each cluster to be selected rather than simply the most relevant of all tags. Thereby, the tags can vary from general to specific.

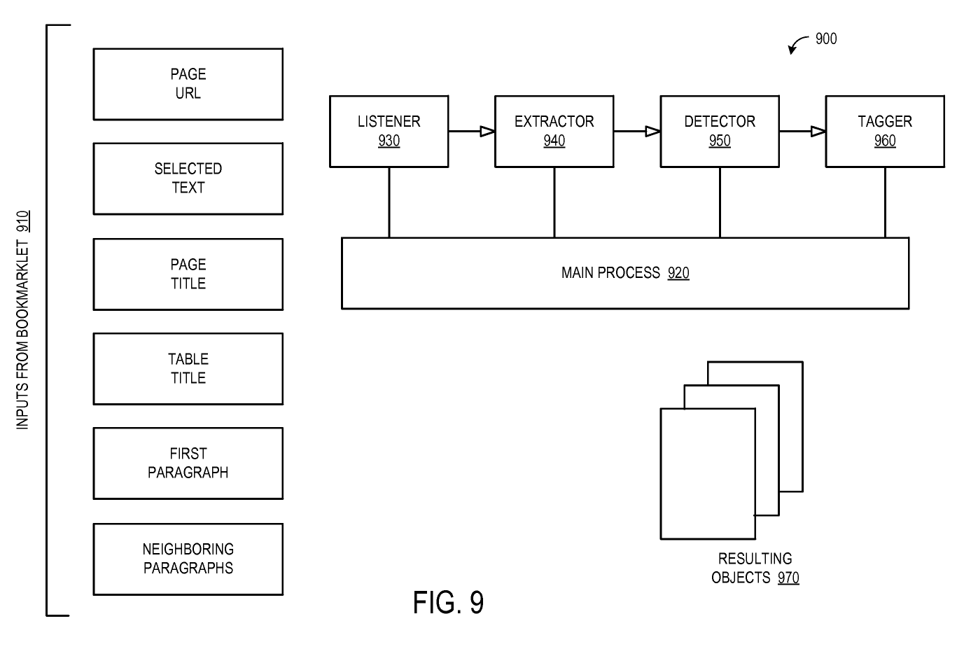

FIG. 9 is a block diagram of a system architecture 900 according to some embodiments of the present invention. The architecture 900 might be, for example, associated with a bookmarklet that provides inputs 910 including a page Uniform Resource Locator (URL), selected text, a page title, a table title, a fight paragraph (e.g., the first paragraph on the web page that contains the table), and neighboring paragraphs.

The bookmarklet may be implemented in Javascript, while the backend code may be written in Java. In some cases, an entity extractor may be used, such as, SAP® BusinessObjects™ Text Analysis SDK (formerly called Inxight ThingFinder's Java API). For example, when the systems extracts metadata from the webpage that contains the dataset of interest to the user, entities may be pulled from each part (title, first paragraph, paragraphs immediately surrounding the dataset, and table title). Entities may also be extracted from the data table itself. For each part, the system may group the extracted entities together into a single string and use these as search terms for the automatic tagging component (e.g., when finding the Google similarity measure).

The entity extractor may also be used during a pseudo relevance process. Here, the system may perform a search using the title of the page or table (whichever is available) as the query. Once the results are obtained, the system may use the entity extractor to determine entities from the snippets. The entity extractor may allow the system to group similar terms together and assign a confidence (e.g., between 0 and 10) and relevance (e.g., between −1 and 100) score to each, depending on the amount of surrounding text and how relevant the entity is to the entire text on the page. The system might use a combination of these scores as follows:

$$tagScore := \frac{confidence \times relevance}{100}$$

The resulting score, tagScore, is a number between 0 and 10. The tags obtained from the pseudo relevance component may sorted according to their tagScore and the ten percent of tags with the greatest scores may be added to the initial tag set.

The architecture may further include a main process 920 that communicates with a listener 930 module in the Java backend. The parsed content may then be sent to an extractor module 940 and detector module 950 which extract the metadata and detect entities in the text. This information is passed to a tagger module 960, which then determines which tags to recommend for this metadata. The result is a PageData object 970 that contains entities and tags, as well as the metadata and table information.

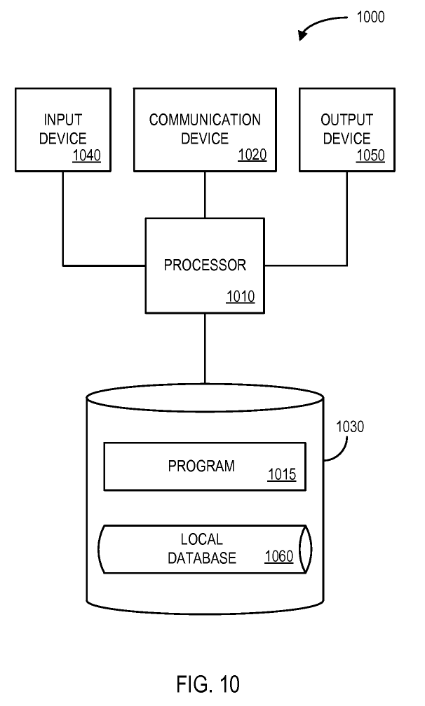

FIG. 10 is a block diagram of an apparatus 1000 in accordance with some embodiments of the present invention. The apparatus 1000 might, for example, execute a process such as the one illustrated in FIGS. 2 and 6 or generate the user interface shown in FIGS. 3, 4, 7 and so on. The apparatus 1000 comprises a processor 1010, such as one or more INTEL® Pentium® processors, coupled to a communication device 1020 configured to communicate via a communication network (not shown in FIG. 10). The communication device 1020 may be used to communicate, for example, with a remote web resource server 120 and a remote data sharing web server 130 via the Internet.

The processor 1010 is also in communication with an input device 1040. The input device 1040 may comprise, for example, a keyboard, a mouse, or computer media reader. Such an input device 1040 may be used, for example, to select a portion of a web page being viewed by a user. The processor 1010 is also in communication with an output device 1050. The output device 1050 may comprise, for example, a display screen or printer. Such an output device 1050 may be used, for example, to provide suggested formatting and/or metadata information to the user.

The processor 1010 is also in communication with a storage device 1030. The storage device 1030 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage device 1030 stores a program 1015 for controlling the processor 1010. The processor 1010 performs instructions of the program 1015, and thereby operates in accordance any embodiments of the present invention described herein. For example, the processor 1010 may receiving information from a remote web resource server 120, the received information including tabular data comprising cells arranged in a plurality of rows and a plurality of columns. The processor 1010 may further receive a user selection of a portion of the received information (including some or all of the tabular data). The processor 1010 may further automatically generate enhanced information associated with the selected portion and arrange to transmit the enhanced information to a remote data sharing web server 130.

As used herein, information may be “received” by or “transmitted” to, for example: (i) the apparatus 1000 from other devices; or (ii) a software application or module within the apparatus 1000 from another software application, module, or any other source. As shown in FIG. 10, the storage device 1030 may also store a local information database 1060 according to some embodiments. The local information database 1060 may, for example, store information about web pages and/or enhanced information associated with selection portions of those web pages.

The illustration and accompanying descriptions of devices and databases presented herein are exemplary, and any number of other arrangements could be employed besides those suggested by the figures. For example, multiple databases associated with different web pages, users, or data sharing web servers might be associated with the apparatus 1000. Similarly, the local information database 1060 may store different types of additional information that may be helpful when generating enhanced information, such as spelling variations (including misspellings and country-specific spelling variations), aliases (e.g., nicknames), and/or language variations (e.g., translated names).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the applications and databases described herein may be combined or stored in separate systems). Similarly, although a particular information flow and user interactions have been given as examples, other and/or additional steps may be performed in accordance with any embodiments described herein. For example, although a particular wizard was described with respect to FIGS. 7 and 8 other implementations might be used instead in accordance with any of the embodiments described herein.

Embodiments described herein may be useful in connection with an access an online business application service, such as, data warehousing, reporting application, sales of data sets, shared data analysis tools, and the like. Examples of such services include web 2.0 sites, social networking sites, ManyEyes from IBM®, GapMinder, and Whohar or OnDemand from SAP® BusinessObjects™. These applications can be hosted on a web server and access across the internet or another network like an intranet. The tabular data may come from a varied of sources including reports, webpages, text documents, spreadsheets, and the like. Each of these may itself include metadata used in constructing a suggested set of tags to the tabular data. Such tabular data once uploaded can be stored in one or more data sources, such as relational, transactional, hierarchical or multi-dimensional databases. The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer-readable medium having stored thereon processor-executable instructions, to facilitate use of a data sharing web server remote from a user device, that when executed by a processor result in the following:
receiving, at the user device, information from a remote web resource server, the received information including tabular data comprising cells arranged in a plurality of rows and a plurality of columns;
receiving, at the user device, a user selection of a portion of the received information, the selected portion including the tabular data;
automatically generating enhanced information associated with the selected portion; and
transmitting the enhanced information to the remote data sharing web server.

2. The medium of claim 1, wherein said automatic generation of the enhanced information includes:
replicating data from a first cell of the tabular data into a second cell.

3. The medium of claim 1, wherein said automatic generation of the enhanced information includes:
formatting the enhanced information to ensure that a first cell is blank.

4. The medium of claim 1, wherein said automatic generation of the enhanced information includes:
determining metadata associated with the tabular data.

5. The medium of claim 4, wherein the metadata includes at least one description of the tabular data.

6. The medium of claim 4, wherein the metadata includes at least one tag for the tabular data.

7. The medium of claim 4, wherein at least one tag is automatically determined based on at least one of: (i) preset general tags, (ii) keywords, (iii) a pseudo-relevance process, (iv) a clustering process, (v) search results associated with the tabular data, (vi) a relevance score, or (vii) a confidence score.

8. The medium of claim 1, wherein said automatic generation of the enhanced information includes:
automatically generating suggested enhanced information associated with the selected portion; and
receiving from the user an indication associated with the suggested enhanced information, wherein the transmitted enhanced information is based at least in part on the received indication.

9. The medium of claim 1, wherein the automatic generation of the enhanced information includes:
receiving a set of entities associated with the selection portion;
determining an initial tag set for the selected portion;
transmitting queries to a remote search engine;
receiving results from the remote search engine;
clustering the initial tag set based on the received results;
determining a similarity score for each entity in the set of entities; and
outputting a final list of suggested tags.

10. The medium of claim 1, wherein the remote data sharing web server is associated with a web-based collaboration service for sharing data analytics.

11. A system, comprising:
a communication device to receive information from a remote web resource server, the received information including tabular data comprising cells arranged in a plurality of rows and a plurality of columns; and
an enhancement engine to (i) receiving a user selection of a portion of the received information, the selected portion including the tabular data, and (ii) automatically generate enhanced information associated with the selected portion.

12. The system of claim 11, wherein the automatic generation of the enhanced information includes replicating data from a first cell of the tabular data into a second cell.

13. The system of claim 11, wherein the automatic generation of the enhanced information includes formatting the enhanced information to ensure that a first cell is blank.

14. The system of claim 11, wherein the automatic generation of the enhanced information includes determining metadata associated with the tabular data.

15. The system of claim 14, wherein the metadata includes at least one of (i) a description of the tabular data or (ii) a tag for the tabular data.

16. The system of claim 11, wherein the automatic generation of the enhanced information includes: (i) automatically generating suggested enhanced information associated with the selected portion, and (ii) receiving from the user an indication associated with the suggested enhanced information, wherein enhanced information transmitted to a remote data sharing web server is based at least in part on the received indication.

17. The system of claim 11, wherein the remote data sharing web server is associated with a web-based collaboration service for sharing data analytics.

18. A method, comprising:
receiving, at the user device, information from a remote web resource server, the received information including tabular data comprising cells arranged in a plurality of rows and a plurality of columns;
receiving, at the user device, a user selection of a portion of the received information, the selected portion including the tabular data;
automatically generating enhanced information associated with the selected portion; and
transmitting the enhanced information to the remote data sharing web server.

19. The method of claim 18, wherein said automatic generation of the enhanced information includes:
replicating data from a first cell of the tabular data into a second cell.

20. The method of claim 19, wherein said automatic generation of the enhanced information includes:
automatically generating suggested enhanced information associated with the selected portion; and
receiving from the user an indication associated with the suggested enhanced information, wherein the transmitting enhanced information is based at least in part on the received indication.

21. The method of claim 20, wherein the remote data sharing web server is associated with a web-based collaboration service for sharing data analytics.

22. A method to facilitate use of a data sharing web server remote from a user device, comprising:
receiving, at the user device, information from a remote web resource server, the received information including tabular data comprising cells arranged in a plurality of rows and a plurality of columns;
receiving, at the user device, a user selection of a portion of the received information, the selected portion including the tabular data;
receiving a set of entities associated with the selection portion;
determining an initial tag set for the selected portion;
transmitting queries to a remote search engine based at least in part on the initial tag set;
receiving results from the remote search engine;
clustering the initial tag set based on the received results;
determining a similarity score for each entity in the set of entities; and
transmitting a list of automatically suggested tags to a remote data sharing web server.

23. The method of claim 22, wherein said clustering is associated with at least one of: (i) an adapted quality threshold clustering method, or (ii) an agglomerative hierarchical clustering method.
